(19) United States
(12) Patent Application Publication
(10) Pub. No.: US 2003/0044126 A1
(43) Pub. Date: Mar. 6, 2003

(54) Optical module and method of manufacturing the optical module

(76) Inventors: Minoru Kawano, Tokyo (JP); Shinichi Ooe, Tokyo (JP); Katsuhiko Goto, Tokyo (JP); Toshio Sogo, Tokyo (JP)

Correspondence Address: Platon N. Mandros, BURNS, DOANE, SWECKER & MATHIS, L.L.P., P.O. Box 1404, Alexandria, VA, 22313-1404, US

(21) Appl. No.: 10/086,861

(22) Filed: Mar. 4, 2002

(30) Foreign Application Priority Data
Aug. 31, 2001 (JP) 2001-262983

(51) Int. Cl. G02B 6/42; G02B 6/255

(52) U.S. Cl. 385/88; 385/96

(57) ABSTRACT

A leading fiber penetrates through a holding element and is optically coupled to an optical element placed in a package. An external cord fiber longer than the leading fiber passes a through hole of a glass sleeve and is connected to the leading fiber to form an optical fiber composed of the leading fiber and the external cord fiber. The holding element is inserted into the glass sleeve to place a fusion-spliced portion between the leading fiber and the external cord fiber in the through hole of the glass sleeve. UV hardening resin hardened by receiving ultraviolet rays is packed and hardened in the through hole of the glass sleeve to cover the fusion-spliced portion with the UV hardening resin and the glass sleeve.

### BACKGROUND OF THE INVENTION

1. Field of the Invention

The present invention relates to an optical module applicable for a pig-tail type optical module and a method of manufacturing the optical module.

2. Description of Related Art

Recently, a large volume of information has been transmitted at high speed in network communication. Therefore, network communication using optical fibers has been put to practical use. In this optical fiber network communication, an optical module is used to change an electric signal to an optical signal or to change an optical signal to an electric signal, and a large volume of information is transmitted at high speed through an optical fiber.

In this optical module, an optical signal is received or output in/from an optical element, and the optical signal is transmitted through an optical fiber. In this case, to transmit the optical signal without deteriorating information included in the optical signal, it is required to place the optical element and the optical fiber with high positioning precision and to transmit the optical signal, for example, output from the optical element to an end surface of the optical fiber at an appropriate illumination intensity.

Therefore, a pig-tail type optical module is widely used. In this pig-tail type optical module, a lens is used to converge an optical signal output from an optical element, and the optical element, the lens and an optical fiber are fixed in a package so as to focus the optical signal converged by the lens on the end surface of the optical fiber.

However, in this pig-tail type optical module, the optical fiber is fixed in the package so as to focus the optical signal converged by the lens on the end surface of the optical fiber. Therefore, a problem has arisen that it is required to prepare the lens with high processing precision and it is difficult to adjust an optical axis of the optical element.

To solve this problem, a surface mounting type optical module is proposed. In this surface mounting type optical module, an optical element and an optical fiber placed near to each other are directly mounted on a substrate. Therefore, it is easy to adjust the optical axis of the optical element, and an optical signal output from the optical element can be transmitted to an end surface of the optical fiber at an appropriate illumination intensity.

In this surface mounting type optical module, the optical fiber is directly mounted on the substrate to obtain a positional precision in the mounting of both the optical element and the optical fiber (or a precision of the optical coupling of the optical element with the optical fiber), and the optical signal output from the optical element is transmitted to the optical fiber at an appropriate illumination intensity.

However, because the optical fiber generally has a length ranging from 1 to 3 m, it is troublesome to handle the optical fiber in the manufacturing of the surface mounting type optical module. For example, when the optical fiber is positioned while considering the position of the optical element, because the optical fiber is long, the optical fiber easily get caught in a manufacturing machine. Also, because the optical fiber is wound in a circle and held in a storehouse for a long time, the optical fiber easily rolls up in a circle in the manufacturing of the optical module. Therefore, a problem has arisen that the surface mounting type optical module cannot be efficiently manufactured.

### SUMMARY OF THE INVENTION

An object of the present invention is to provide, with due consideration to the drawbacks of the conventional optical module, an optical module which is easily manufactured by making easy the handling of an optical fiber while maintaining the precision of the optical coupling of the optical fiber to another optical element.

Also, the object of the present invention is to provide a method of manufacturing the optical module.

The object is achieved by the provision of an optical module comprising an optical element, a supporting element configured to support the optical element, a first optical fiber having a first end optically coupled to the optical element and a second end placed near to the supporting element, and a second optical fiber fusion-spliced to the first optical fiber.

In the above configuration, because the second optical fiber is fusion-spliced to the first optical fiber to form an optical fiber, the optical fiber can be easily handled while maintaining the precision of the optical coupling of the optical fiber to the optical element, and the optical module having the optical fiber easily handled can be obtained.

It is preferred that a fusion-spliced portion between the first optical fiber and the second optical fiber is supported by the supporting element.

Therefore, the fusion-spliced portion between the first optical fiber and the second optical fiber can be stably supported.

The object is also achieved by the provision of an optical module comprising an optical element, a supporting element configured to support the optical element, a first optical fiber optically coupled to the optical element, a second optical fiber connected to the first optical fiber, and a resin element which is supported by the supporting element and with which a connected portion between the first optical fiber and the second optical fiber is covered.

In the above configuration, because the first optical fiber and the second optical fiber are connected to each other to form an optical fiber, the optical fiber can be easily handled while maintaining the precision of the optical coupling of the optical fiber to the optical element, and the optical module having the optical fiber easily handled can be obtained.

Also, because the fusion-spliced portion between the first optical fiber and the second optical fiber is covered with the resin element, the fusion-spliced portion can be protected from the outside air, and the fusion-spliced portion can be prevented from being broken due to moisture included in the outside air.

It is preferred that the connected portion between the first optical fiber and the second optical fiber is obtained by fusion splicing between the first optical fiber and the second optical fiber.

Therefore, the first optical fiber and the second optical fiber can be reliably connected to each other.

It is also preferred that the optical module further comprises a sleeve with which the resin element is covered.

Therefore, the fusion-spliced portion between the first optical fiber and the second optical fiber can be protected from the external force.

It is also preferred that a through hole or a plurality of through holes are arranged in the sleeve.

Therefore, the resin element can be packed into the sleeve through one through hole. Also, because the air is discharged from the other though holes, the resin element can uniformly spread into the sleeve.

It is also preferred that one of the through holes is placed almost on the center of a peripheral surface of the sleeve.

Therefore, the resin element can uniformly spread into the sleeve by injecting the resin element from the through hole placed almost on the center of a peripheral surface of the sleeve.

It is also preferred that the sleeve is made of a substance through which ultraviolet rays are transmitted, and the resin element is hardened by receiving the ultraviolet rays.

Therefore, the resin element can be reliably hardened.

It is also preferred that the sleeve is made of glass.

Therefore, the ultraviolet rays can be reliably transmitted through the sleeve.

It is also preferred that the optical module further comprises a resilient hood which is attached to the sleeve from a side of the second optical fiber so as to cover the sleeve and from which the second optical fiber is protruded.

Therefore, because the second optical fiber just protruded from the sleeve is protected by the resilient hood, the hood can prevent the second optical fiber from being broken.

It is also preferred that a thickness of the hood at a protruding portion of the second optical fiber is more than that of the hood at the other portions.

Therefore, the hood can further prevent the second optical fiber from being broken.

It is also preferred that the hood is made of rubber.

Therefore, the hood can reliably prevent the second optical fiber from being broken.

It is also preferred that the optical module further comprises a holding element configured to be fitted to the sleeve, and a fixing member configured to fix the holding element on the supporting element.

Therefore, because the sleeve is indirectly fixed to the supporting element, the combination of the first optical fiber and the second optical fiber can be stably position in the optical module.

It is also preferred that the holding element holds the first optical fiber by using thermosetting resin packed in the holding element.

Therefore, when the holding element has not been yet fitted to the sleeve, the thermosetting resin packed in the holding element can be easily heated in a furnace to harden thermosetting resin.

It is also preferred that the sleeve and the holding element are made of the same substance as each other, and the resin element hardened by receiving ultraviolet rays is placed in a fitting space between the sleeve and the holding element.

Therefore, the sleeve and the holding element can be tightly attached together to the hardened resin element.

It is also preferred that a groove is formed on the holding element, and the resin element is packed in the groove of the holding element.

Therefore, even though a fitting strength between the holding element and the sleeve is weakened, the holding element and the sleeve can be tightly attached to each other through the resin element packed in the groove of the holding element.

It is also preferred that the holding element and the first optical fiber lead out from the holding element are covered with resin on the supporting element.

Therefore, the resin can prevent the first optical fiber lead out from the holding element from being broken due to moisture of the outside air.

It is also preferred that the supporting element comprises a package to seal the optical element, the package has a protrusive portion on an outside surface so as to hold the first optical fiber, and the package is configured to make the protrusive portion fit to the sleeve.

Therefore, the structure of the optical module can be simplified.

It is also preferred that a groove is formed on a peripheral surface of the protrusive portion.

Therefore, even though a fitting strength between the protrusive portion and the sleeve is weakened, the protrusive portion and the sleeve can be tightly attached to each other through the resin element packed in the groove of the protrusive portion.

The object is achieved by the provision of a method of manufacturing an optical module, comprising the steps of supporting a first optical fiber on a supporting element while optically coupling an optical element supported on the supporting element to the first optical fiber, fusion-splicing the first optical fiber to a second optical fiber longer than the first optical fiber to each other, inserting a fusion-spliced portion between the first optical fiber and the second optical fiber into a sleeve, and packing resin into the sleeve in which the fusion-spliced portion is inserted.

Therefore, because the first optical fiber and the second optical fiber are connected to each other as an optical fiber, the optical fiber can be easily handled while maintaining the precision of the optical coupling of the optical fiber to the optical element, and the optical module having the optical fiber can be easily manufactured.

It is preferred that the method of manufacturing the optical module further comprises the step of hardening the resin packed into the sleeve.

Therefore, the fusion-spliced portion between the first optical fiber and the second optical fiber can be tightly fixed to the sleeve through the hardened resin.

It is also preferred that the step of supporting the first optical fiber on the supporting element comprises the steps of inserting the first optical fiber into a holding element, packing resin into the holding element in which the first optical fiber is inserted, and placing the holding element on a fixing member to fix the holding element on the supporting element and to support the first optical fiber on the supporting element. Also, the step of inserting the fusion-spliced portion comprises the step of fitting the holding element to the sleeve to insert the fusion-spliced portion into the sleeve.

Therefore, the first optical fiber inserted into the holding element can be fixed to the supporting element so as to be coupled to the optical element, and the second optical fiber and the first optical fiber fusion-spliced to the second optical fiber can be held in the holding element and the sleeve.

It is also preferred that the step of supporting the first optical fiber on the supporting element further comprises the step of hardening the resin packed into the holding element by heating the resin.

Therefore, the first optical fiber inserted into the holding element can be tightly fixed to the holding element due to the hardened resin. Also, because the hardened resin is not further hardened when the resin element packed in the sleeve is hardened, a fixing strength of the first optical fiber to the holding element is not weakened.

### BRIEF DESCRIPTION OF THE DRAWINGS

FIG. 1 is a diagonal view showing an external structure of a pig-tail type optical module according to a first embodiment of the present invention;

FIG. 2 is a diagonal view showing an internal structure of the pig-tail type optical module shown in FIG. 1;

FIG. 3 is a sectional view taken substantially along line A-A of FIG. 1;

FIG. 4 is a sectional view taken substantially along line B-B of FIG. 3;

FIG. 5A is a diagonal perspective view of a cylindrical glass sleeve;

FIG. 5B is a sectional view taken substantially along line C-C of FIG. 5A;

FIG. 6 shows a step of fixing a leading fiber to the holding element 16;

FIG. 7 shows a step of aligning a leading fiber with an optical element in a package;

FIG. 8 shows a step of inserting an external cord fiber into both a glass sleeve and a rubber hood;

FIG. 9 shows a step of connecting the external cord fiber to the leading fiber;

FIG. 10 shows a step of inserting a holding element into a glass sleeve;

FIG. 11 shows a step of packing UV hardening resin into the glass sleeve;

FIG. 12 shows a step of radiating ultraviolet rays to the UV hardening resin through the glass sleeve;

FIG. 13 shows a step of covering the glass sleeve with a rubber hood;

FIG. 14 shows a step of packing resin in both a space between the package and a fixing member and a U-shaped hole of the fixing member;

FIG. 15 is a vertical sectional view of a pig-tail type optical module according to a second embodiment of the present invention;

FIG. 16 is a diagonal view of both a holding element and a glass sleeve according to a third embodiment of the present invention;

FIG. 17 is a diagonal view of both a holding element and a glass sleeve according to a modification of the third embodiment of the present invention;

FIG. 18 is a diagonal view of a glass sleeve according to a sixth embodiment of the present invention; and

FIG. 19 is a diagonal view of both a holding element and a fixing member according to a seventh embodiment of the present invention.

### DETAILED DESCRIPTION OF THE PREFERRED EMBODIMENTS

Embodiments of the present invention will now be described with reference to the accompanying drawings.

Embodiment 1

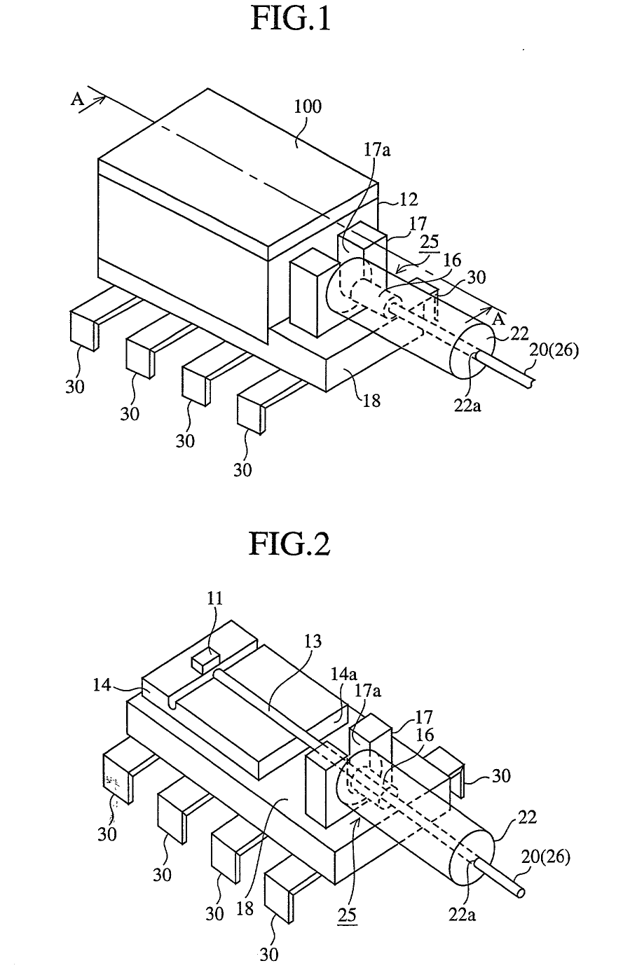

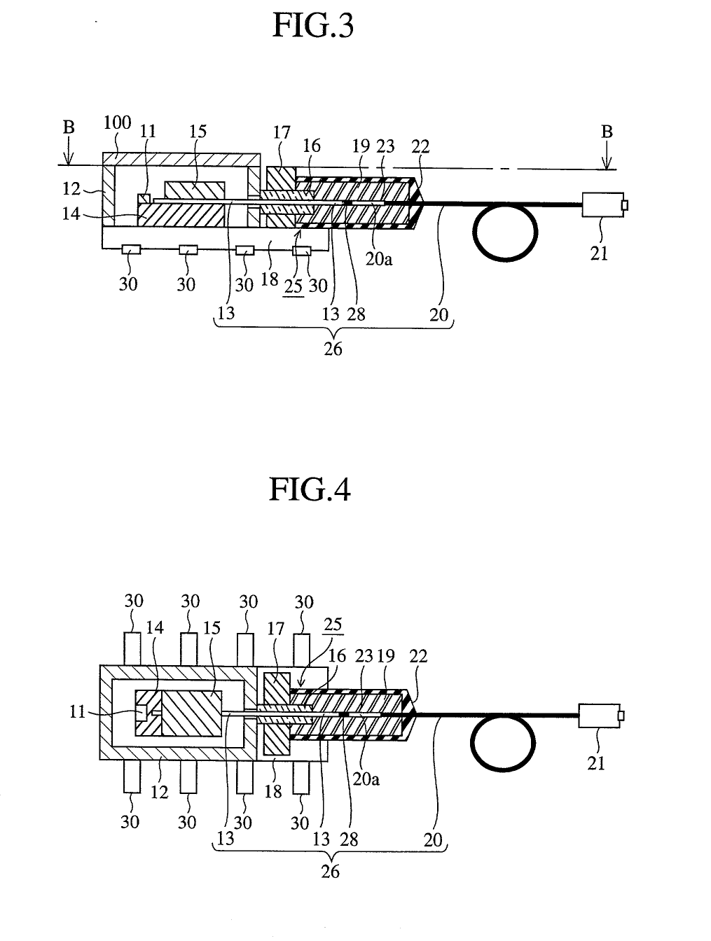

FIG. 1 is a diagonal view showing an external structure of a pig-tail type optical module according to a first embodiment of the present invention. FIG. 2 is a diagonal view showing an internal structure of the pig-tail type optical module shown in FIG. 1. FIG. 3 is a sectional view taken substantially along line A-A of FIG. 1. FIG. 4 is a sectional view taken substantially along line B-B of FIG. 3.

In FIG. 1, FIG. 2, FIG. 3 and FIG. 4, 11 indicates an optical element formed of a laser diode. 26 indicates an optical fiber configured to transmit an optical signal output from the optical element 11. The optical fiber 26 is composed of a leading fiber (or a first fiber) 13 and an external cord fiber (or a second fiber) 20 longer than the leading fiber 13. The leading fiber 13 has a length ranging from 1 to 3 cm for example. One end of the external cord fiber 20 is connected to one end of the leading fiber 13. 14 indicates a first Si substrate on which the optical element 11 and the leading fiber 13 are mounted. A V-shaped groove 14a is formed on the first Si substrate 14. 15 indicates a second Si substrate placed on the first Si substrate 14.

The leading fiber 13 is placed in the V-shaped groove 14a of the first Si substrate 14 and is fixed between the first Si substrate 14 and the second Si substrate 15.12 indicates a package in which the optical element 11, the leading fiber 13, the first Si substrate 14 and the second Si substrate 15 are placed. The package 12 is formed of a ceramic substance. 100 indicates a cover placed on the upper portion of the package 12. The cover 100 is formed of the ceramic substance. 25 indicates a fiber connecting unit configured to connect the leading fiber 13 with the external cord fiber 20. The fiber connecting unit 25 is place on one side of the package 12.

A through hole 12a is formed in a side surface of the package 12 facing the fiber connecting unit 25, and the leading fiber 13 is lead from the inside of the package 25 to the outside through the through hole 12a of the package 12. The diameter of the through hole 12a is larger than that of the leading fiber 13, and the internal surface of the through hole 12a is coated with resin so as to place the leading fiber 13 at an optimum position. That is to say, the leading fiber 13 lead out from the package 12 through the through hole 12a is fixed without receiving an external force.

18 indicates a plate-shaped supporting stand. The package 12 and the fiber connecting unit 25 are mounted on the supporting stand 18. The supporting stand 18 and the first Si substrate 14 function as a supporting element configured to support the optical element 11.

21 indicates an optical connector connected to the other end of the external cord fiber 20. An SC connector is, for example, applied for the optical connector 21. 30 indicates a plurality of lead terminals through which electric signals are transmitted between a pig-tail type optical module (hereinafter, simply called an optical module) and an external device.

In the package 12, a mark (not shown) is engraved on the first Si substrate 14 according to a photo-engraving process to position the optical element 11 on the first Si substrate 14 with high precision, and the V-shaped groove 14a is formed on the first Si substrate 14 according to an anisotropic etching process using chemicals. The position of the V-shaped groove 14a is determined on the basis of the mark to position the leading fiber 13 placed in the V-shaped groove 14a with high precision. In this case, the leading fiber 13 of the optical fiber 26 is pushed down toward the deepest area of the V-shaped groove 14a by the second Si substrate 15. Therefore, the leading fiber 13 is supported by both side surfaces of the V-shaped groove 14a and a surface of the second Si substrate 15 contacting with the leading fiber 13. Accordingly, a position of the leading fiber 13 relative to the optical element 11 is set with high precision, and the optical signal output from the optical element 11 can be received in the leading fiber 13 without reducing an illumination intensity of the optical signal.

The fiber connecting unit 25 comprises a cylindrical glass sleeve 19 configured to hold the leading fiber 13 lead out from the package 12 and the external cord fiber 20, a cylindrical holding element 16 configured to hold the leading fiber 13, a fixing member 17 configured to support the cylindrical holding element 16, a rubber hood 22 configured to covering the glass sleeve 19, and an ultraviolet (UV) hardening resin 23 packed into a through hole of the glass sleeve 19.

The fixing member 17 is placed on the supporting stand 18 and has a U-shaped hole 17a extending downward from the upper side. One end portion of the holding element 16 is attached to the inner surface of the U-shaped hole 17a of the fixing member 17 by using a binding substance. Therefore, the holding element 16 is fixed to the fixing member 17, and the leading fiber 13 lead out from the package 12 passes through the U-shaped hole 17a of the fixing member 17.

The holding element 16 is formed of a glass substance, and a through hole 16a having a diameter slightly larger than that of the leading fiber 13 is formed in the holding element 16. The through hole 16a extends from one end face to the other end face of the cylindrical holding element 16, and the leading fiber 13 lead out from the package 12 penetrates through the through hole 16a of the holding element 16. To fix the leading fiber 13 in the holding element 16, thermosetting resin is injected into the through hole 16a through which the leading fiber 13 penetrates. Therefore, the leading fiber 13 is held by the hardened thermosetting resin in the holding element 16.

In this case, because the position of the leading fiber 13 relative to the optical element 11 is set with high precision by pushing down the leading fiber 13 toward the deepest area of the V-shaped groove 14a by the second Si substrate 15, it is not required to set a diameter of the cylindrical holding element 16, a diameter of the through hole 16a and the position of the through hole 16a with high precision.

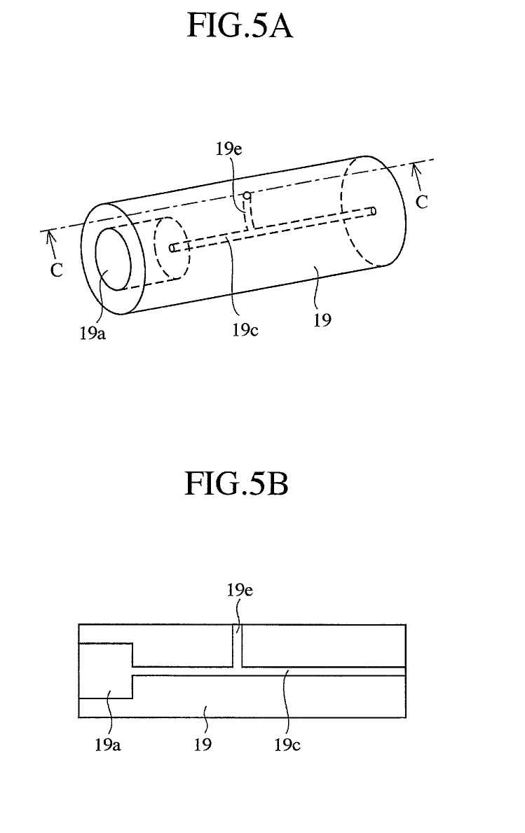

FIG. 5A is a diagonal perspective view of the cylindrical glass sleeve 19, and FIG. 5B is a sectional view taken substantially along line C-C of FIG. 5A.

In FIG. 5A and FIG. 5B, the cylindrical glass sleeve 19 is formed of the same glass substance as that of the cylindrical holding element 16. A columnar inserting hole 19a having almost the same diameter as an outer diameter of the holding element 16 is formed on one end face of the cylindrical glass sleeve 19. The holding element 16 is inserted into the columnar inserting hole 19a of the cylindrical glass sleeve 19. A through hole 19c has a diameter slightly larger than an outer diameter (generally, 0.9 mm) of the external cord fiber 20 and straightly extends from the bottom center of the columnar inserting hole 19a to the center of the other end face of the cylindrical glass sleeve 19 in the longitudinal direction of the glass sleeve 19. The leading fiber 13 is lead from the holding element 16 inserted into the columnar inserting hole 19a of the cylindrical glass sleeve 19 to the through hole 19c of the cylindrical glass sleeve 19, and the leading fiber 13 is connected to the external cord fiber 20 in the through hole 19c of the cylindrical glass sleeve 19. Also, a resin injecting hole 19e is formed in the cylindrical glass sleeve 19 and extends from a side face of the cylindrical glass sleeve 19 to the through hole 19c. The UV hardening resin 23 is injected into the resin injecting hole 19e to pack the UV hardening resin 23 into the through hole 19c in which the leading fiber 13 and the external cord fiber 20 connected to each other are inserted. In this case, the resin injecting hole 19e is placed in the middle of the both end faces of the cylindrical glass sleeve 19 so as to uniformly spread the UV hardening resin 23 into the whole through hole 19c. Therefore, the leading fiber 13 and the external cord fiber 20 are fixedly held in the through hole 19c of the cylindrical glass sleeve 19 by hardening the UV hardening resin 23.

The leading fiber 13 of the optical fiber 26 has a core and a clad functioning as an optical fiber, and no coating process is performed for the outside surface of the clad. That is to say, the clad of the leading fiber 13 is uncovered, and an optical fiber having the uncovered clad is called an optical fiber core wire. The external cord fiber 20 of the optical fiber 26 has a core and a clad covered with a resin layer. The resin layer is obtained by coating the outside surface of the clad with polyamide resin. The resin layer is removed from one end portion of the external cord fiber 20 to form an optical fiber core wire portion 20a at the end portion of the external cord fiber 20.

The end face of the leading fiber 13 is tightly connected to the end face of the optical fiber core wire portion 20a of the external cord fiber 20 according to an electric discharge fusion splicing process. A connected portion of the optical fiber 26 is called a fusion-spliced portion 28. One end portion of the leading fiber 13, the fusion-spliced portion 28, the optical fiber core wire portion 20a and a part of the external cord fiber 20 are inserted into the through hole 19c of the cylindrical glass sleeve 19 and are protected from both the external force. Also, the UV hardening resin 23 hardened in the through hole 19c of the cylindrical glass sleeve 19 protects the optical fiber 26 inserted into the through hole 19c from moisture included in the outside air. Here, the UV hardening resin 23 is hardened by radiating ultraviolet rays to the UV hardening resin 23.

Also, the UV hardening resin 23 has the property of easily wetting the glass. Therefore, an attaching strength of the hardened UV hardening resin 23 to the glass sleeve 19, the holding element 16, the leading fiber 13 and the optical fiber core wire portion 20a of the external cord fiber 20 can be heightened, the glass sleeve 19 protects the fusion-spliced portion 28 of the optical fiber 26, and the optical fiber 26 can be reliably connected to the package 12 through the holding element 16.

Also, the glass sleeve 19 is covered with the rubber hood 22, and a through hole 22a is formed in the top portion of the rubber hood 22. The external cord fiber 20 lead out from the glass sleeve 19 penetrates through the through hole 22a of the rubber hood 22 and is lead to the outside. The rubber hood 22 is thickened at a portion around the through hole 22a. Therefore, when stress excessively occurs in the external cord fiber 20 due to an external force, the stress of the external cord fiber 20 is absorbed by the elasticity of the rubber hood 22 thickened around the external cord fiber 20 so as to prevent the external cord fiber 20 lead out from the glass sleeve 19 from being forcedly bent, and the external cord fiber 20 is prevented from being bent at a sharp angle at the outlet of the glass sleeve 19. Therefore, the rubber hood 22 prevents the external cord fiber 20 lead out from the glass sleeve 19 from being bent.

Also, the rubber hood 22 shields the UV hardening resin 23 packed into the glass sleeve 19 from ultraviolet rays. Therefore, even though the optical module receives ultraviolet rays during the operation of the optical module, the rubber hood 22 prevents the UV hardening resin 23 packed into the glass sleeve 19 from being excessively hardened.

In this embodiment, in place of the rubber hood 22, it is applicable that all surface of the glass sleeve 19 is coated with an ultraviolet ray shielding substance. Therefore, the ultraviolet ray shielding substance prevents the UV hardening resin 23 packed into the glass sleeve 19 from being excessively hardened. In this case, to prevent the external cord fiber 20 lead out from the glass sleeve 19 from being bent, it is required to cover a surface of the glass sleeve 19 near to the external cord fiber 20 lead out from the glass sleeve 19 with a rubber hood shorter than the rubber hood 22.

Also, in the first embodiment, the holding element 16 is formed of the same glass substance as that of the cylindrical glass sleeve 19 so as to be tightly attached to the UV hardening resin 23, and the cylindrical holding element 16 is attached to the fixing member 17. However, because the thermosetting resin is packed into the through hole 16a of the cylindrical holding element 16, even though the thermosetting resin of the holding element 16 receives ultraviolet rays from the outside in a manufacturing step of the optical module on condition that the cylindrical holding element 16 is not covered with the rubber hood 22, no influence is exerted on the leading fiber 13 fixed to the cylindrical holding element 16 through the thermosetting resin.

Next, a manufacturing method of the optical module according to the first embodiment of the present invention will be described below.

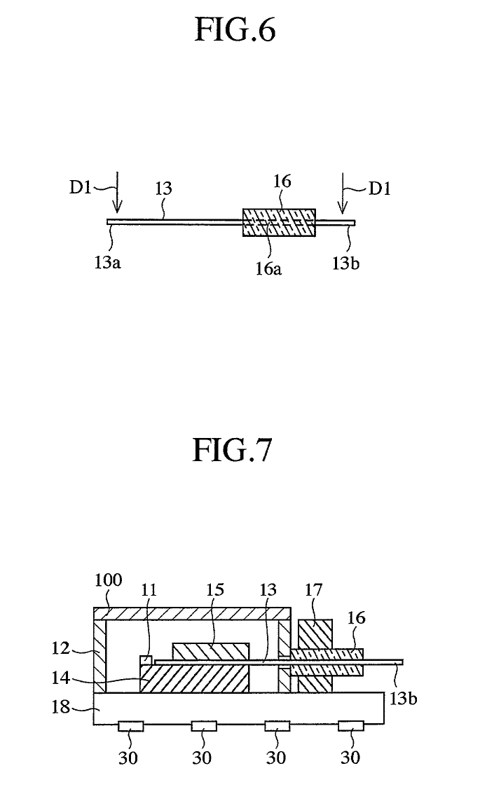

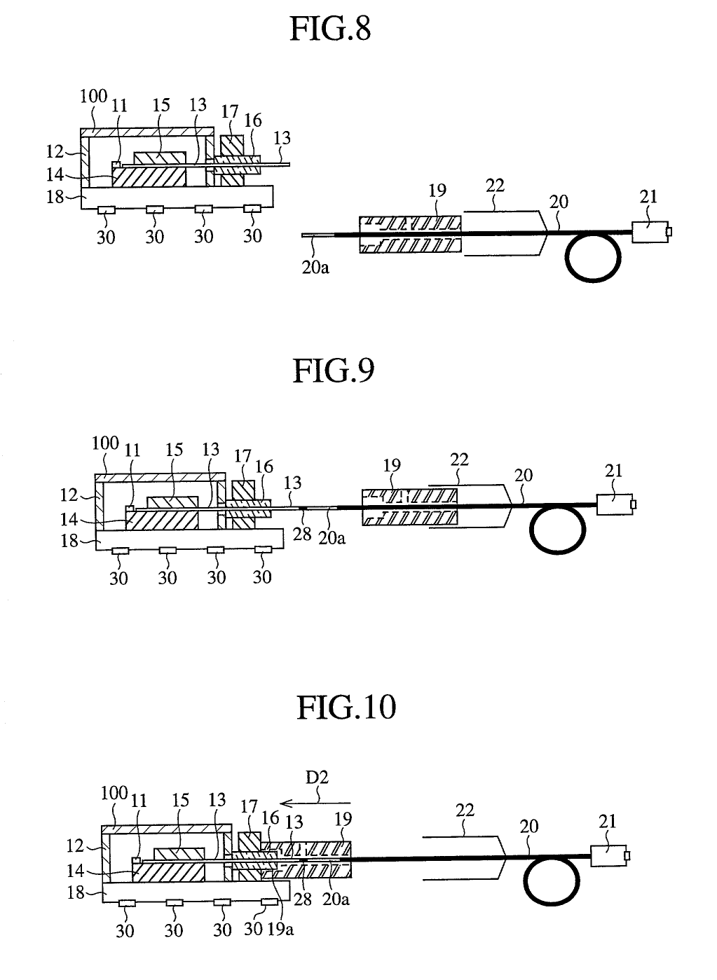

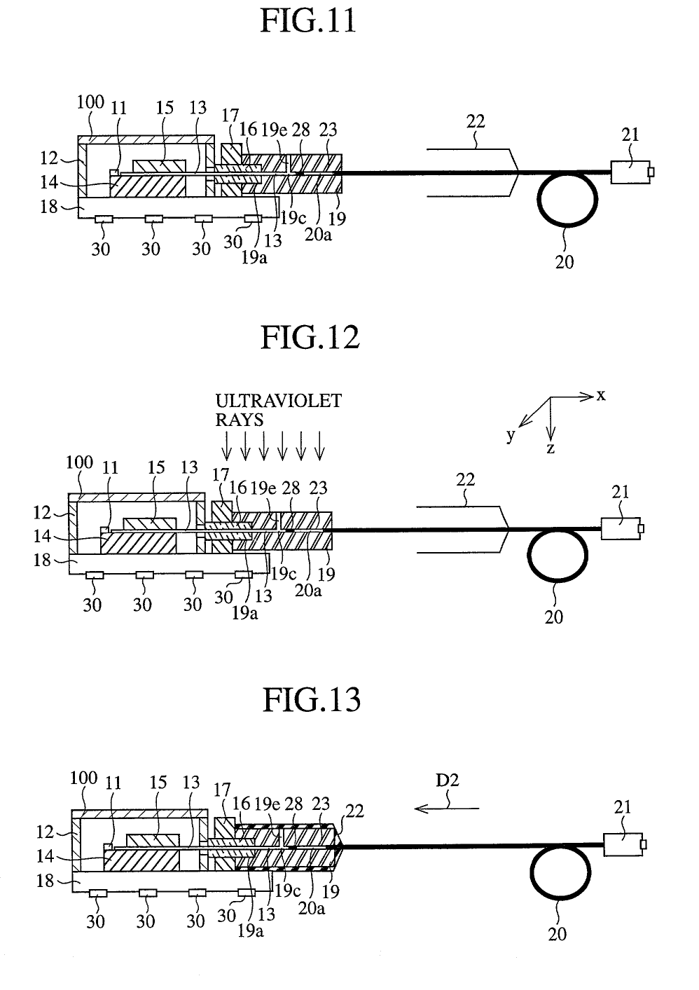

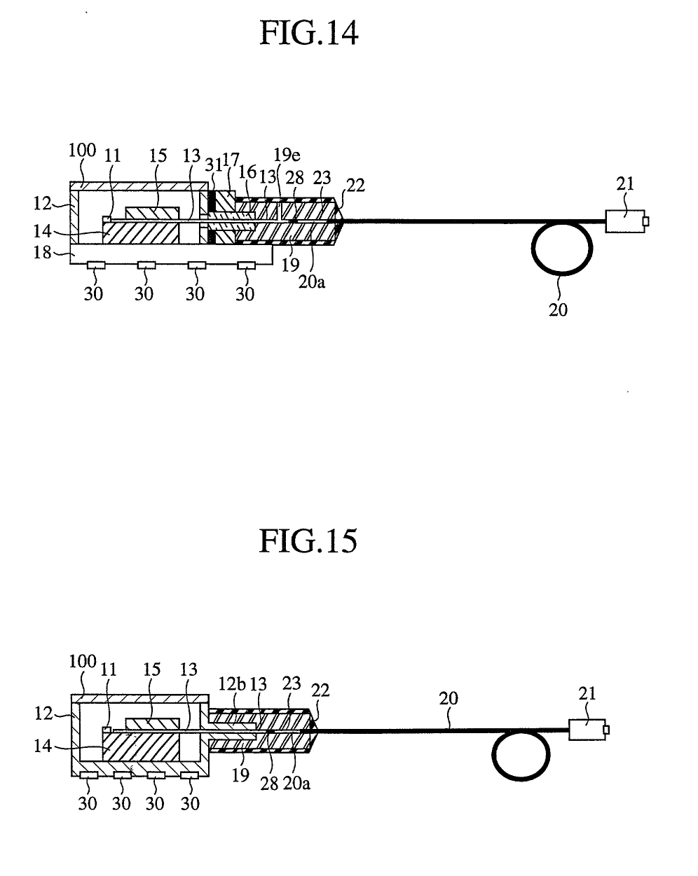

FIG. 6 shows a step of fixing the leading fiber 13 to the holding element 16, FIG. 7 shows a step of aligning the leading fiber 13 with the optical element 11 in the package 12, FIG. 8 shows a step of inserting the external cord fiber 20 into both the glass sleeve 19 and the rubber hood 22, FIG. 9 shows a step of connecting the external cord fiber 20 to the leading fiber 13, FIG. 10 shows a step of inserting the holding element 16 into the glass sleeve 19, FIG. 11 shows a step of packing the UV hardening resin 23 into the glass sleeve 19, FIG. 12 shows a step of radiating ultraviolet rays to the UV hardening resin 23 through the glass sleeve 19, FIG. 13 shows a step of covering the glass sleeve 19 with the rubber hood 22, FIG. 14 shows a step of packing resin in both a space between the package 12 and the fixing member 17 and the U-shaped hole 17a of the fixing member 17.

In the manufacturing process, in cases where moisture included in the air is attached to the core wire of the leading fiber 13, there is probability that the leading fiber 13 is broken. Therefore, the manufacturing process of the optical module is performed in the dry environment.

As shown in FIG. 6, the leading fiber 13 set to an appropriate length (for example, ranging from 1 to 3 cm) is inserted into the through hole 16a of the cylindrical holding element 16 so as to protrude both end portions of the leading fiber 13 from the holding element 16. Thereafter, the thermosetting resin is injected into the through hole 16a of the holding element 16, and the holding element 16 is heated in a baking furnace (not shown) to harden the thermosetting resin placed between the holding element 16 and the leading fiber 13. Therefore, the leading fiber 13 is fixed to the holding element 16.

In this case, because the holding element 16 having the leading fiber 13 has not yet connected to the package 12, the holding element 16 having the leading fiber 13 can be easily placed in the baking furnace of a small size. Therefore, the UV hardening resin is not used, but the thermosetting resin is used to fix the leading fiber 13 to the holding element 16. Also, in cases where a plurality of holding elements 16 respectively having the leading fiber 13 are simultaneously heated in the baking furnace, the productivity of the optical module can be improved.

Thereafter, a cut is engraved in each of both end portions 13a and 13b of the leading fiber 13 by slightly cutting the end portions 13a and 13b with a cutter in a cutting direction D1 perpendicular to the longitudinal direction of the leading fiber 13, an external force is added to the cuts of the both end portions 13a and 13b of the leading fiber 13 from the cutting direction D1 to cut out the both end portions 13a and 13b of the leading fiber 13. That is to say, the both end portions 13a and 13b of the leading fiber 13 are cloven.

In this case, the end face of the end portion 13b of the leading fiber 13 is used to be connected to one end face of the external cord fiber 20, and the end face of the end portion 13a of the leading fiber 13 is used to be coupled to a laser beam radiated from the optical element 11. Therefore, it is required to clean up end faces of the both end portions 13a and 13b of the leading fiber 13. Here, it is applicable that the both end portions 13a and 13b of the leading fiber 13 be cloven at a slant and end faces of the both end portions 13a and 13b of the leading fiber 13 be cleaned up.

Thereafter, as shown in FIG. 7, the package 12 and the fixing member 17 are mounted on the supporting stand 18, the first Si substrate 14 is placed in a space of the package 12, the optical element 11 is arranged at a position of a mark engraved on the first Si substrate 14, a part of the leading fiber 13 attached to the holding element 16 is inserted into the through hole 12a of the package 12 through the U-shaped hole 17a of the fixing member 17, and the leading fiber 13 is placed in the V-shaped groove 14a of the first Si substrate 14. Thereafter, the position of the leading fiber 13 is adjusted so as to make a laser beam radiated from the optical element 11 be incident on the end face of the end portion 13a of the leading fiber 13 at an appropriate illumination intensity. Therefore, a laser beam radiated from the optical element 11 is coupled to the end face of the end portion 13a of the leading fiber 13. In this case, because the leading fiber 13 is shorter than a cord fiber used for the conventional pig-tail type optical module, the position of the leading fiber 13 can be easily adjusted, and the leading fiber 13 can be easily handled in the manufacturing process.

Thereafter, the second Si substrate 15 is placed on the first Si substrate 14 and is fixed to the first Si substrate 14 so as to push down the leading fiber 13. Therefore, the leading fiber 13 is supported by both side surfaces of the V-shaped groove 14a of the first Si substrate 14 and a bottom surface of the second Si substrate 15 contacting with the leading fiber 13, and the leading fiber 13 is placed at a fixed position. In this case, assuming that the height of the through hole 12a of the package 12 differs from the height of the V-shaped groove 14a of the first Si substrate 14, a stress is added to the leading fiber 13 placed in the V-shaped groove 14a. Therefore, to add no stress to the leading fiber 13, the through hole 12a of the package 12 and the V-shaped groove 14a of the first Si substrate 14 are formed so as to make the height of the through hole 12a be equal to the height of the V-shaped groove 14a.

Thereafter, the cylindrical holding element 16 is put in the U-shaped hole 17a of the fixing member 17 and is attached to the inside surface of the U-shaped hole 17a by using a binding substance. Thereafter, the cover 100 is put on the package 12, and the package 12 is hermetically sealed. Therefore, the manufacturing process of the package 12 is completed on condition that the leading fiber 13 is lead out from the package 12.

Therefore, because the length of the leading fiber 13 is short, a main body of the optical module having the optical element 11, the first Si substrate 14, the second Si substrate 15, the package 12 and the leading fiber 13 lead out from the package 12 can be manufactured without being disturbed by the leading fiber 13, and the manufacturing efficiency of the optical module can be improved.

Thereafter, as shown in FIG. 8, the external cord fiber 20 is inserted into both the through hole 22a of the rubber hood 22 and the through hole 19c of the glass sleeve 19. For example, the length of the external cord fiber 20 ranges from 50 cm to 2 m. Thereafter, the coating layer of the end portion of the external cord fiber 20 placed on the side of the glass sleeve 19 is peeled off to expose the optical fiber core wire portion 20a placed at the end portion of the external cord fiber 20, and the top of the optical fiber core wire portion 20a is cloven perpendicularly to the longitudinal direction of the external cord fiber 20.

Thereafter, as shown in FIG. 9, the core of the leading fiber 13 is aligned with the core of the optical fiber core wire portion 20a of the external cord fiber 20 with high precision by using a microscope. Thereafter, an electric discharge fusion-splicing process is performed for contact portions of both the leading fiber 13 and the optical fiber core wire portion 20a facing each other. In detail, a discharge current flows through the contact portions to melt the contact portions, and the discharge current is stopped. Therefore, the leading fiber 13 and the optical fiber core wire portion 20a of the external cord fiber 20 are tightly connected to each other at the fusion-spliced portion 28 according to the electric discharge fusion-splicing process.

In the experiment of inventors of this specification, an energy loss of the optical signal at the fusion-spliced portion 28 of the leading fiber 13 and the optical fiber core wire portion 20a is measured to be about 0.03 dB. Therefore, the leading fiber 13 and the optical fiber core wire portion 20a of the external cord fiber 20 can be connected to each other at a low energy loss.

Thereafter, as shown in FIG. 10, the glass sleeve 19 is moved toward the cylindrical holding element 16 in a direction D2 while placing both the fusion-spliced portion 28 and the optical fiber core wire portion 20a of the external cord fiber 20 into the through hole 19c of the glass sleeve 19, and the holding element 16 is inserted into the columnar inserting hole 19a of the glass sleeve 19. Therefore, the leading fiber 13, the fusion-spliced portion 28, the optical fiber core wire portion 20a and a part of the external cord fiber 20 are covered with the glass sleeve 19, and the optical fiber 26 can be prevented from being broken by moisture of the air.

Thereafter, as shown in FIG. 11, the UV hardening resin 23 is injected into the resin injecting hole 19e of the glass sleeve 19 and uniformly spreads into the open space of the through hole 19c of the glass sleeve 19. Also, the UV hardening resin 23 injected into the resin injecting hole 19e reaches the columnar inserting hole 19a and uniformly spreads into the narrow space between the glass sleeve 19 and the holding element 16. Also, the UV hardening resin 23 spreading into the through hole 19c further uniformly spreads into an inserting area from which the external cord fiber 20 is inserted into the through hole 19c.

The UV hardening resin 23 has the property of easily wetting the leading fiber 13, the optical fiber core wire portion 20a, the glass sleeve 19 and the holding element 16. Also, the UV hardening resin 23 has viscosity so as to prevent the UV hardening resin 23 packed in the through hole 19c of the glass sleeve 19 from leaking out to the outside. Also, there is probability that a fiber core wire formed of the leading fiber 13, the fusion-spliced portion 28 and the optical fiber core wire portion 20a sink in the UV hardening resin 23 packed in the through hole 19c of the glass sleeve 19. In this case, the UV hardening resin 23 is unevenly distributed around the fiber core wire. Therefore, there is probability that air bubbles are generated around the fiber core wire. In this case, when the air bubbles attached to the fiber core wire are heated after hardening the UV hardening resin 23 of the glass sleeve 19, the air bubbles are expanded. Therefore, there is probability that the fiber core wire is broken.

To prevent the fiber core wire from being broken by the air bubbles, the UV hardening resin 23 of the glass sleeve 19 is hardened while supporting both end portions of the fiber core wire inserted into the glass sleeve 19.

Thereafter, as shown in FIG. 12, ultraviolet rays are radiated to the UV hardening resin 23 uniformly spreading in the glass sleeve 19 through the glass sleeve 19 from an upper direction (or a Z direction) to harden the UV hardening resin 23. In this case, the first embodiment is not limited to the radiation of the ultraviolet rays from the upper direction. For example, it is applicable that the ultraviolet rays be radiated to the UV hardening resin 23 from a horizontal direction (or an Y direction) or both horizontal directions (or X and Y directions) perpendicular to each other. In cases where the ultraviolet rays be radiated to the UV hardening resin 23 from the both horizontal directions, because the radiation of the ultraviolet ray is not disturbed by the supporting stand 18, the UV hardening resin 23 can be efficiently hardened.

Therefore, the fiber core wire including the fusion-spliced portion 28 is covered with the hardened UV hardening resin 23, and the fiber core wire can be prevented from coming in contact with the outside air. Accordingly, the fiber core wire can be prevented from being broken. Also, because the fusion-spliced portion 28 is fixed to the glass sleeve 19 by the hardened UV hardening resin 23 packed in the glass sleeve 19, no burden is added to the fusion-spliced portion 28.

Also, the hardened UV hardening resin 23 used to fix the leading fiber 13, the fusion-spliced portion 28 and the optical fiber core wire portion 20a to the glass sleeve 19 is not further hardened by heat. Therefore, as compared with the use of the thermosetting resin, the influence of heat on the leading fiber 13, the fusion-spliced portion 28 and the optical fiber core wire portion 20a can be reduced.

Thereafter, as shown in FIG. 13, the rubber hood 22 is moved toward the glass sleeve 19 in the direction D2 while placing the external cord fiber 20 in the through hole 22a of the rubber hood 22, and the glass sleeve 19 is covered with the rubber hood 22.

Thereafter, as shown in FIG. 14, a space between the fixing member 17 and one side surface of the package 12 facing the fixing member 17 is filled up with resin 31, and the U-shaped hole 17a of the fixing member 17 is filled up with the resin 31. Therefore, because the through hole 12a of the package 12 is filled up with the resin 31, no outside air enters the package 12 through the through hole 12a, and the leading fiber 13 can be prevented from being broken by the outside air. Also, because the leading fiber 13 not covered with the holding element 16 but lead out from the package 12 is covered with the resin 31, the leading fiber 13 can be prevented from being broken by moisture included in the outside air.

Also, because the U-shaped hole 17a of the fixing member 17 is filled up with the resin 31, the holding element 16 can be further tightly supported by the fixing member 17 and the resin 31. Therefore, even though the holding element 16 attached to the fixing member 17 by the binding substance comes off from the fixing member 17 due to a difference in linear expansion coefficient between the holding element 16 and the fixing member 17, the holding element 16 can be still supported by the fixing member 17 in cooperation with the resin 31.

As is described above, in the manufacturing process of the optical module according to the first embodiment, the leading fiber 13 of the short length is used in the aligning step of the optical element 11 and the optical fiber 26, and the external cord fiber 20 is connected to the leading fiber 13 according to the electric discharge fusion-splicing process. Accordingly, the leading fiber 13 can be reliably connected to the package 12 while easily handling the leading fiber 13, and the pig-tail type optical module can be easily manufactured at high manufacturing efficiency.

In similar to the pig-tail type optical module in which the external cord fiber 20 is connected to the leading fiber 13 lead out from the package 12 in the above-described manufacturing process, a receptacle type optical module is well known. In this receptacle type optical module, an optical fiber is detachable from a main body of the optical module. In detail, the receptacle type optical module has both a ferrule fixing the optical fiber and a receptacle fitted to the ferrule. In the receptacle, an optical element is arranged, and a laser beam radiated from the optical element is coupled to the optical fiber attached to the ferrule. However, because the optical fiber is not directly attached to the receptacle having the optical element, it is difficult to focus the laser beam radiated from the optical element on an end face of the optical fiber (hereinafter, this focusing is called core alignment). Therefore, the laser coupling performance in the receptacle type optical module is inferior to that in the pig-tail type optical module.

Also, in the receptacle type optical module, even though the precision in the manufacturing of the ferrule is heightened, precisions of the ferrule in the outer diameter, the inner diameter, eccentricity (a position of a hole shifting from the center of an outline having the outer diameter) and circularity (a degree of the outline shifting from a complete round) are unevenly distributed within tolerance. Therefore, the core alignment cannot be completely achieved in the manufacturing of the ferrule, and optical characteristics in the receptacle type optical module are unstable.

Accordingly, the optical fiber can be easily handled in the manufacturing of the pig-tail type optical module according to the first embodiment in the same manner as in the receptacle type optical module, and the optical coupling performance (or optical characteristics) of the pig-tail type optical module manufactured according to the first embodiment is superior to that of the receptacle type optical module.

In the first embodiment, the leading fiber 13 has no coating layer so as to be an optical fiber core wire, and the clad of the entire leading fiber 13 is uncovered. However, it is applicable that a part of the leading fiber 13 not covered with the holding element 16 or the glass sleeve 19 has a coating layer around the clad and the other part of the leading fiber 13 having the uncovered clad is covered with the combination of the holding element 16 and the glass sleeve 19. In this case, the leading fiber 13 can be further prevented from being broken due to moisture included in the outside air.

Also, in the first embodiment, a laser diode is used as the optical element 11. However, it is applicable that a photo diode be used as the optical element 11.

Also, in the first embodiment, the UV hardening resin 23 is packed in the glass sleeve 19 to fix the leading fiber 13 and the external cord fiber 20 to the glass sleeve 19. However, it is applicable that the UV hardening resin 23 be packed in a mold having the same external shape as that of the glass sleeve 19 so as to cover the holding element 16, the leading fiber 13 and the external cord fiber 20 with the hardened UV hardening resin 23.

Also, in the first embodiment, the rubber hood 22 is attached to the glass sleeve 19 to protect the external cord fiber 20 just protruded from the glass sleeve 19. However, resin having a resilient property in the hardened condition is prepared, and it is applicable that the hardened resilient resin be attached to the glass sleeve 19 in place of the rubber hood 22.

Also, in the first embodiment, the hardened UV hardening resin 23 is packed in the through hole 19c of the glass sleeve 19. However, it is applicable that the hardened resilient resin be packed in the through hole 19c of the glass sleeve 19. In this case, it is preferable that the resin not hardened be gathered around the external cord fiber 20 according to the surface tension of the resin. Also, in the first embodiment, the UV hardening resin 23 is packed in the glass sleeve 19. However, it is applicable that thermosetting resin be packed in the glass sleeve 19 in place of the UV hardening resin 23. In this case, this thermosetting resin is hardened at temperatures lower than 80° C. not to further harden the thermosetting resin packed in the through hole 16a of the holding element 16. Also, in cases where the thermosetting resin be packed in the glass sleeve 19 in place of the UV hardening resin 23, it is not required to use the glass sleeve 19 through which the ultraviolet rays are transmitted. Therefore, it is applicable that a sleeve formed of a ceramic substance be used in place of the glass sleeve 19.

Also, in the first embodiment, the package 12 is formed of a ceramic substance. However, it is applicable that a resin mold box be formed by covering a transfer mold with black resin and the resin mold box be used in place of the package 12.

Also, in the first embodiment, the hood 22 is formed of rubber. However, it is applicable that the hood 22 is formed of resilient synthetic resin.

Also, in the first embodiment, the fusion-spliced portion 28 between the leading fiber 13 and the external cord fiber 20 is fixed in the UV hardening resin 23 packed in the glass sleeve 19. However, it is applicable that the fusion-spliced portion 28 between the leading fiber 13 and the external cord fiber 20 be placed out of the glass sleeve 19. In this case, the manufacturing process of the optical module can be simplified. However, because the strength of the fusion-spliced portion 28 between the leading fiber 13 and the external cord fiber 20 is weakened against the external force, it is required not to give a load on the fusion-spliced portion 28.

Embodiment 2

FIG. 15 is a vertical sectional view of a pig-tail type optical module according to a second embodiment of the present invention.

In the first embodiment, the holding element 16 and the package 12 are separately formed. However, in a second embodiment, as shown in FIG. 15, it is applicable that the package 12 having a protrusive portion 12a be formed in place of the combination of the package 12 and the holding element 16 placed on an outside surface of the package 12. In this case, the leading fiber 13 is inserted into the protrusive portion 12a of the package 12. Therefore, it is not required to arrange the fixing member 17 or the supporting stand 18. Accordingly, the manufacturing process of the pig-tail type optical module can be shortened.

Embodiment 3

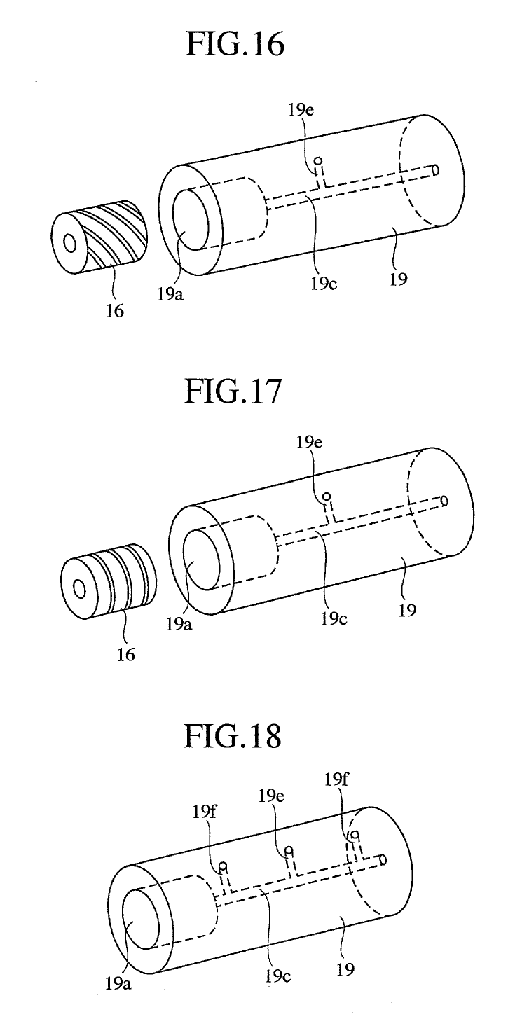

FIG. 16 is a diagonal view of both the holding element 16 and the glass sleeve 19 according to a third embodiment of the present invention, and FIG. 17 is a diagonal view of both the holding element 16 and the glass sleeve 19 according to a modification of the third embodiment of the present invention.

In the first embodiment, no groove is formed on the outer surface of the holding element 16 contacting with the inner surface of the glass sleeve 19. However, as shown in FIG. 16, in the third embodiment, a screw-shaped groove 16b is formed on the outer surface of the holding element 16. In this case, when the UV hardening resin 23 is injected into the glass sleeve 19, the UV hardening resin 23 uniformly spreads into the screw-shaped groove 16b of the holding element 16 inserted into the glass sleeve 19.

Accordingly, even though the UV hardening resin 23 does not sufficiently spread into a space between the holding element 16 and the glass sleeve 19 so as to weaken a degree of the strength of the attachment of the holding element 16 to the glass sleeve 19, because the hardened UV hardening resin 23 is uniformly packed into the screw-shaped groove 16b of the holding element 16, the glass sleeve 19 can be prevented from detaching from the holding element 16.

In the third embodiment, the screw-shaped groove 16b is formed on the outer surface of the holding element 16. However, as shown in FIG. 17, it is applicable that a plurality of circular grooves 16c be serially formed on the outer surface of the holding element 16.

Embodiment 4

In the first embodiment, the glass sleeve 19 is made of glass to harden the UV hardening resin 23 packed in the glass sleeve 19 by radiating ultraviolet rays to the UV hardening resin 23 through the glass sleeve 19. However, in a fourth embodiment, a resin sleeve formed of a transparent resin is used in place of the glass sleeve 19. In this case, though a manufacturing cost of the optical module is heightened as compared with that using the glass sleeve 19, a degree of the attachment of the hardened UV hardening resin 23 to the resin sleeve is heightened, and the optical fiber 26 inserted into the resin sleeve can be preferably protected.

Embodiment 5

In the first embodiment, the cylindrical holding element 16 is formed in a circular shape in section. However, in a fifth embodiment, the holding element 16 is formed in a polygonal shape (for example, rectangular shape) or a circle-segment shape (for example, semi-circular shape) in section. Also, a sectional shape of the columnar inserting hole 19 of the glass sleeve 19 is the same as that of the holding element 16. Therefore, the attachment of the holding element 16 to the glass sleeve 19 can be strengthened.

Embodiment 6

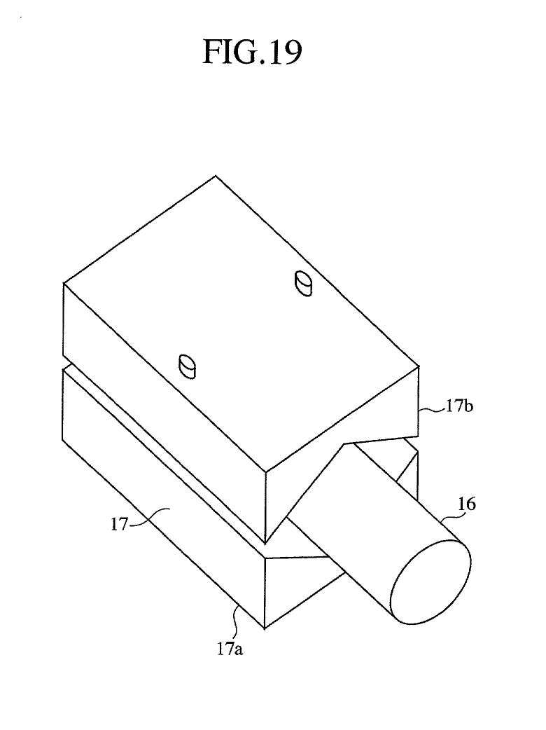

FIG. 18 is a diagonal view of the glass sleeve 19 according to a sixth embodiment of the present invention.

In the first embodiment, the glass sleeve 19 has the resin injecting hole 19e. However, in a sixth embodiment, the glass sleeve 19 has one or a plurality of air discharging holes 19f in addition to the resin injecting hole 19e. Therefore, when the UV hardening resin 23 is injected into the resin injecting hole 19e, the air packed in the through hole 19c of the glass sleeve 19 can be easily discharged from the air discharging holes 19f. Accordingly, the UV hardening resin 23 can be uniformly packed in the glass sleeve 19.

Embodiment 7

FIG. 19 is a diagonal view of both the holding element 16 and the fixing member 17 according to a seventh embodiment of the present invention.

In the first embodiment, the holding element 16 is put into the U-shaped hole 17a of the fixing member 17 to support the holding element 16 with the fixing member 17. However, in a seventh embodiment, the fixing member 17 comprises a lower portion 17a and an upper portion 17b, and each of the portions 17a and 17b has a V-shaped groove. The holding element 16 is placed in the V-shaped grooves between the portions 17a and 17b to support the holding element 16 with the fixing member 17.

Therefore, the holding element 16 can be reliably supported by the fixing member 17.

What is claimed is:

1. An optical module comprising:
an optical element;
a supporting element configured to support the optical element;
a first optical fiber having a first end optically coupled to the optical element and a second end placed near to the supporting element; and
a second optical fiber fusion-spliced to the first optical fiber.

2. An optical module according to claim 1, wherein a fusion-spliced portion between the first optical fiber and the second optical fiber is supported by the supporting element.

3. An optical module comprising:
an optical element;
a supporting element configured to support the optical element;
a first optical fiber optically coupled to the optical element;
a second optical fiber connected to the first optical fiber; and
a resin element which is supported by the supporting element and with which a connected portion between the first optical fiber and the second optical fiber is covered.

4. An optical module according to claim 3, wherein the connected portion between the first optical fiber and the second optical fiber is obtained by fusion splicing between the first optical fiber and the second optical fiber.

5. An optical module according to claim 3, wherein the optical module further comprises a sleeve with which the resin element is covered.

6. An optical module according to claim 5, wherein a through hole or a plurality of through holes are arranged in the sleeve.

7. An optical module according to claim 6, wherein one of the through holes is placed almost on the center of a peripheral surface of the sleeve.

8. An optical module according to claim 5, wherein the sleeve is made of a substance through which ultraviolet rays are transmitted, and the resin element is hardened by receiving the ultraviolet rays.

9. An optical module according to claim 8, wherein the sleeve is made of glass.

10. An optical module according to claim 5, wherein the optical module further comprises a resilient hood which is attached to the sleeve from a side of the second optical fiber so as to cover the sleeve and from which the second optical fiber is protruded.

11. An optical module according to claim 10, wherein a thickness of the hood at a protruding portion of the second optical fiber is more than that of the hood at the other portions.

12. An optical module according to claim 10, wherein the hood is made of rubber.

13. An optical module according to claim 5, wherein the optical module further comprises
a holding element configured to be fitted to the sleeve; and
a fixing member configured to fix the holding element on the supporting element.

14. An optical module according to claim 13, wherein the holding element holds the first optical fiber by using thermosetting resin packed in the holding element.

15. An optical module according to claim 14, wherein the sleeve and the holding element are made of the same substance as each other, and the resin element hardened by receiving ultraviolet rays is placed in a fitting space between the sleeve and the holding element.

16. An optical module according to claim 14, wherein a groove is formed on the holding element, and the resin element is packed in the groove of the holding element.

17. An optical module according to claim 14, wherein the holding element and the first optical fiber lead out from the holding element are covered with resin on the supporting element.

18. An optical module according to claim 5, wherein the supporting element comprises a package to seal the optical element, the package has a protrusive portion on an outside surface so as to hold the first optical fiber, and the package is configured to make the protrusive portion fit to the sleeve.

19. An optical module according to claim 18, wherein a groove is formed on a peripheral surface of the protrusive portion.

20. A method of manufacturing an optical module, comprising the steps of:
supporting a first optical fiber on a supporting element while optically coupling an optical element supported on the supporting element to the first optical fiber;
fusion-splicing the first optical fiber to a second optical fiber longer than the first optical fiber to each other;
inserting a fusion-spliced portion between the first optical fiber and the second optical fiber into a sleeve; and
packing resin into the sleeve in which the fusion-spliced portion is inserted.

21. A method of manufacturing an optical module according to claim 20, further comprising the step of:
hardening the resin packed into the sleeve.

22. A method of manufacturing an optical module according to claim 20, wherein the step of supporting the first optical fiber on the supporting element comprises the steps of:
inserting the first optical fiber into a holding element;
packing resin into the holding element in which the first optical fiber is inserted; and
placing the holding element on a fixing member to fix the holding element on the supporting element and to support the first optical fiber on the supporting element, and the step of inserting the fusion-spliced portion comprises the step of
fitting the holding element to the sleeve to insert the fusion-spliced portion into the sleeve.

23. A method of manufacturing an optical module according to claim 22, wherein the step of supporting the first optical fiber on the supporting element further comprises the step of:
hardening the resin packed into the holding element by heating the resin.
